(19) United States
(12) Patent Application Publication
(10) Pub. No.: US 2013/0156369 A1
(43) Pub. Date: Jun. 20, 2013

(54) RING RESONATORS HAVING Si AND/OR SiN WAVEGUIDES

(71) Applicants: Sahnggi Park, Daejeon (KR); Kap-Joong Kim, Daejeon (KR); In Gyoo Kim, Daejeon (KR); Gyungock Kim, Daejeon (KR)

(72) Inventors: Sahnggi Park, Daejeon (KR); Kap-Joong Kim, Daejeon (KR); In Gyoo Kim, Daejeon (KR); Gyungock Kim, Daejeon (KR)

(73) Assignee: Electronics and Telecommunications Research Institute, Daejeon (KR)

(21) Appl. No.: 13/535,746

(22) Filed: Jun. 28, 2012

(30) Foreign Application Priority Data
Dec. 16, 2011 (KR) 10-2011-0136714

(51) Int. Cl. G02B 6/12

(52) U.S. Cl. 385/14

(57) ABSTRACT

Provided is a ring resonator including first and second waveguides disposed spaced apart from each other, on a substrate, and at least one channel including at least one ring waveguide arranged in a row between the first and second waveguides. The first and second waveguides and the ring waveguide may be formed of silicon, a width of the ring waveguide may range from 0.7 μm to 1.5 μm, a height of the ring waveguide may range from 150 nm to 300 nm, and a space between the first and second waveguides and the ring waveguide most adjacent thereto may range from 250 nm to 1 mm.

### CROSS-REFERENCE TO RELATED APPLICATIONS

This U.S. non-provisional patent application claims priority under 35 U.S.C. §119 to Korean Patent Application No. 10-2011-0136714, filed on Dec. 16, 2011, in the Korean Intellectual Property Office, the entire contents of which are hereby incorporated by reference.

### BACKGROUND OF THE INVENTION

Embodiments of the inventive concepts relate to a photonics device, and in particular, to a ring resonator including a ring waveguide formed of Si or SiN.

According to the miniaturization and high-speed trends of electronic devices, researches are continuing in order to increase the integration density of components which constitute the electronic devices. For the miniaturization and high-speed operation of the electronic devices, a rapid signal transmission between the components is required.

As a way of rapid signal transmission between the components, an application of optical communication technologies to electronic devices is being attempted. In the case where the optical communication technologies are applied to the electronic devices, it is possible to increase a signal transmission speed and reduce technical difficulties in the conventional method, such as high resistance, heating, and parasitic capacitance.

The optical communication technologies may be realized using optical devices including an optical switch, an optical modulator, a multiplexer (MUX)/demultiplexer (DEMUX) filter and the like, in addition to a light source and an optical detector. Silica optical devices have been used as main components in an optical splitter and a wavelength division device for an optical fiber communication, and polymer optical devices have been used as main components in a light source and an optical detector for compound semiconductors along with the silica optical devices. All of the optical devices (e.g., the optical switch, the optical modulator, and the MUX/DEMUX filter) are normally operated, only when a light of a specific wavelength is used; that is, they have dependence on the wavelength.

By using optical waveguides with wavelength dependence, the ring resonator (or optical resonator) may be used as the optical devices (e.g., the optical switch, the optical modulator, and the MUX/DEMUX filter). However, for this, it is necessary to minimize a statistical error in a resonance wavelength of the ring resonator resulting from its fabrication process, to equalize resonance wavelengths of the ring waveguides, and to have a way capable of realizing shortest gaps between the ring waveguide and a bus line or between the ring waveguides using a simple process such as a photolithography process.

### SUMMARY

Example embodiments of the inventive concept provide an optimized ring resonator.

According to example embodiments of the inventive concepts, a ring resonator may include first and second waveguides disposed spaced apart from each other, on a substrate, and at least one channel including at least one ring waveguide arranged in a row between the first and second waveguides. The first and second waveguides and the ring waveguide may be formed of silicon, a width of the ring waveguide ranges from 0.7 μm to 1.5 μm, a height of the ring waveguide ranges from 150 nm to 300 nm, and a space between the first and second waveguides and the ring waveguide most adjacent thereto ranges from 250 nm to 1 mm.

In example embodiments, each channel may include a plurality of ring waveguides provided spaced apart from each other between the first and second waveguides, and a space between the ring waveguides ranges from 250 nm to 1 mm. At least one channel may include a plurality of channels provided spaced apart from each other between the first and second waveguides. A radius of the ring waveguide ranges from 5 μm to 15 μm. The first waveguide may include an input port and a through port, and the second waveguide may include an add port and a drop port.

In example embodiments, the ring resonator may further include a dielectric layer covering the first and second waveguides and the ring waveguide. The dielectric layer may be formed of oxide (SiO2), silicon oxynitride (SiON), or polymer. The ring resonator may further include a supplementary dielectric layer interposed between the first, second and ring waveguides, and the dielectric layer. The supplementary dielectric layer may be formed of silicon oxynitride(SiON). The first and second waveguides and the ring waveguide may be configured to allow a light of TM mode to propagate.

According to example embodiments of the inventive concepts, a ring resonator may include first and second waveguides disposed spaced apart from each other, on a substrate, and at least one channel including at least one ring waveguide arranged in a row between the first and second waveguides. The first and second waveguides and the ring waveguide may be formed of silicon nitride, a width of the ring waveguide ranges from 0.7 μm to 1.8 μm, a height of the ring waveguide ranges from 300 nm to 500 nm, and a space between the first and second waveguides and the ring waveguide most adjacent thereto ranges from 200 nm to 1 mm.

In example embodiments, each channel may include a plurality of ring waveguides provided spaced apart from each other between the first and second waveguides, and a space between the ring waveguides ranges from 200 nm to 1 mm. At least one channel may include a plurality of channels provided spaced apart from each other between the first and second waveguides. A radius of the ring waveguide ranges from 8 μm to 50 μm. The first waveguide may include an input port and a through port, and the second waveguide may include an add port and a drop port. The ring resonator may further include a dielectric layer covering the first and second waveguides and the ring waveguide, and the dielectric layer may be formed of oxide (SiO2) or polymer. The ring resonator may further include a supplementary dielectric layer interposed between the first, second, and ring waveguides and the dielectric layer, and the supplementary dielectric layer may be formed of silicon oxynitride (SiON). The first and second waveguides and the ring waveguide may be configured to allow a light of TE mode to propagate.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1A is a schematic diagram illustrating a ring resonator according to example embodiments of the inventive concept.

FIG. 1B is a SEM image showing a section taken along a line I-I′ of FIG. 1A.

FIGS. 2A through 2D are sectional views illustrating a method of fabricating a ring waveguide of a ring resonator according to example embodiments of the inventive concept.

FIGS. 3A through 3D are diagrams illustrating an operation principle of a ring resonator according to example embodiments of the inventive concept.

FIGS. 4A and 4B are graphs showing transmission spectra of a 16-channel third-order ring resonator according to example embodiments of the inventive concept.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

New research and experiment conducted by the inventors has found an important phenomenon, which can be used in overcoming a statistical error in wavelengths of ring resonators and a technical difficulty in a photolithography process.

The inventors has found that, for a silicon ring resonator, the use of a lowest-order transverse magnetic (TM) mode enables to reduce the statistical error in wavelengths of ring resonators by half or more and to increase minimum distances between a ring waveguide and a bus line or between the ring waveguides to 400 nm or more. This means that a photolithography process can be easily used to fabricate a ring resonator. Hereinafter, this will be described in detail below.

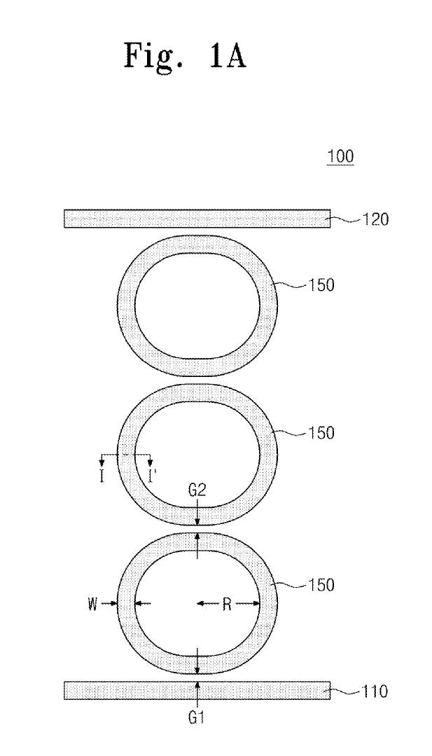

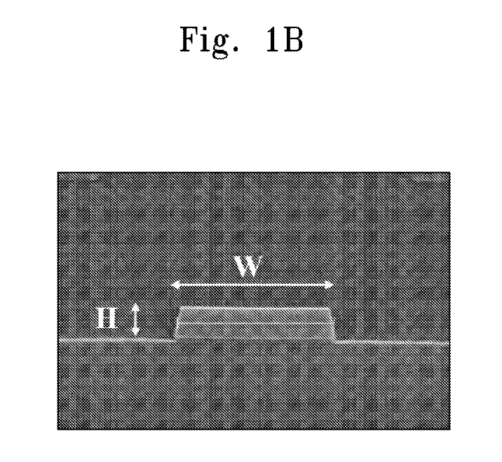

FIG. 1A is a schematic diagram illustrating a ring resonator according to example embodiments of the inventive concept, and FIG. 1B is a SEM image showing a section taken along a line I-I′ of FIG. 1A.

Referring to FIGS. 1A and 1B, a ring resonator 100 may include a first waveguide 110, a second waveguide 120, and at least one ring waveguide 150 disposed between the first and second waveguides 110 and 120. Each of the first and second waveguides 110 and 120 and the ring waveguide 150 may include at least one of silicon (Si) or silicon nitride (Si3N4).

Although not shown, the first and second waveguides 110 and 120 and the ring waveguide 150 may be covered with a dielectric layer, which may have a refractive index lower than the first and second waveguides 110 and 120 and the ring waveguide 150. For example, the dielectric layer may include at least one of silicon oxide (SiO₂) or a polymer (e.g., imide or acrylate). The first and second waveguides 110 and 120 and the ring waveguide 150 may serve as an optical path of light propagation.

The first and second waveguides 110 and 120 may be linearly disposed. For example, the first and second waveguides 110 and 120 may be disposed parallel to each other and be spaced apart from each other with the ring waveguide 150 interposed therebetween. The ring waveguide 150 may be shaped like a ring, and in example embodiments, one or more ring waveguide 150 may be disposed between the first waveguide 110 and the second waveguide 120. The ring waveguide 150 and the first and second waveguides 110 and 120 may be spaced apart from each other. In the case where a plurality of the ring waveguides 150 may be provided, the ring waveguides 150 may be spaced apart from each other.

One or more ring waveguides 150 may be arranged in a row between the first and second waveguides 110 and 120, thereby forming a channel. Although FIG. 1A shows one channel, a plurality of channels may be provided between the first and second waveguides 110 and 120. In example embodiments, the ring resonator 100 may be configured to have 16 or 32 channels, each of which includes one ring waveguide 150 and which are arranged in parallel between the first and second waveguides 110 and 120, thereby forming a 16-channel first-order ring resonator or a 32-channel first-order ring resonator. In other embodiments, the ring resonator 100 may be configured to have 16 or 32 channels, each of which includes three ring waveguides 150 arranged in a row and which are arranged in parallel between the first and second waveguides 110 and 120, thereby forming a 16-channel third-order ring resonator or a 32-channel third-order ring resonator. Each of the channels may be configured to allow a light of respective wavelength to pass therethrough, such that the ring resonator 100 may be used as an optical switch, an optical modulator, a MUX/DEMUX filter.

According to example embodiments of the inventive concept, the ring resonator 100 may be configured to improve transmittance of a light having a specific wavelength. For example, the first and second waveguides 110 and 120 and the ring waveguide 150 may be formed of silicon (Si), and in this case, a width W of the ring waveguide 150 may range from about 0.7 μm to about 1.5 μm and a height H thereof may range from about 150 nm to about 300 nm. A space G1 between the first and second waveguides 110 and 120 and the ring waveguide 150 most adjacent thereto may range from about 250 nm to about 1 mm, and a space G2 between the ring waveguides 150 may range from about 250 nm to about 1 mm. A radius R of the ring waveguide 150 may be greater than about 5 μm.

According to inventor's experiments, in the case in which the first and second waveguides 110 and 120 and the ring waveguide 150 are formed of silicon (Si), an optimized transmission spectrum was obtained from a ring resonator having the width W of about 1 mm, the height H of about 190 nm, the space G1 of about 400 nm, the space G2 of about 500 nm, and the radius R of about 9 mm. For this ring resonator, a light of transverse magnetic (TM) mode may propagate through the ring resonator, but a light of transverse electric (TE) mode may not propagate through the ring resonator because the space between the waveguides or a gap width in the coupling region is too wide for lights of TE mode to be coupled.

In other embodiments, the first and second waveguides 110 and 120 and the ring waveguide 150 may be formed of silicon nitride, and in this case, a width W of the ring waveguide 150 may range from about 0.7 μm to about 1.8 μm, and a height H thereof may range from about 300 nm to about 500 nm. A space G1 between the first and second waveguides 110 and 120 and the ring waveguide 150 most adjacent thereto may range from about 200 nm to about 1 mm, and a space G2 between the ring waveguides 150 may range from about 200 nm to about 1 mm. A radius R of the ring waveguide 150 may range from about 8 μm to about 50 μm.

According to inventor's experiments, in the case in which the first and second waveguides 110 and 120 and the ring waveguide 150 are formed of silicon nitride, an optimized transmission spectrum was obtained from a ring resonator having the width W of about 1.2 mm, the height H of about 400 nm, the space G1 of about 300 nm, the space G2 of about 400 nm, and the radius R of about 13 μm. For this ring resonator, a light of TE mode may propagate through the ring resonator, but a light of TM mode may not propagate through the ring resonator because of a high bending loss with respect to a ring radius.

Both lights of TE and TM modes may be incident to the first and second waveguides 110 and 120 and the ring waveguide 150. The transverse electric (TE) mode represents linearly polarized light whose electric field E is normal to the plane of incidence. The transverse magnetic (TM) mode represents linearly polarized light whose magnetic field is normal to the plane of incidence.

For the Si waveguide, in the case where the spaces G1 and G2 are about 300 nm or more, the ring resonator may allow the TM mode to propagate, but a propagation of the TE mode may not be allowed. In the case in which the spaces G1 and G2 are 300 nm or more, the ring resonator may be formed using a Hg-I line photolithography process.

According to example embodiments of the inventive concept, the ring resonator 100 may include Si waveguides, while it may be configured in such a way that the spaces G1 and G2 are about 300 nm or more. In this case, since the TM mode can propagate along the ring resonator 100, it is possible to improve transmittance of a light having a specific wavelength. In addition, an overall process of fabricating the ring resonator 100 can be simplified by using the simple lithography process. Furthermore, the ring resonator 100 may be configured to reduce an error or non-uniformity in wavelength, thereby having improved reliability.

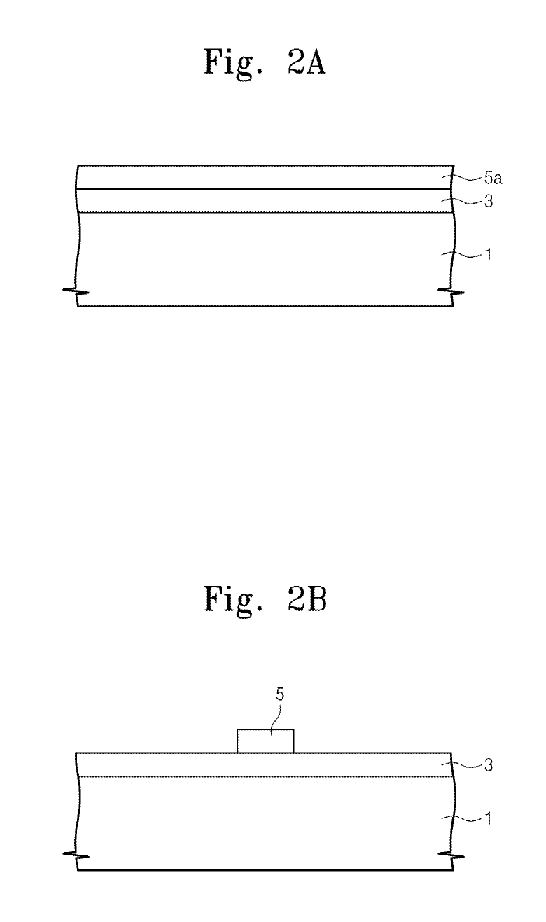

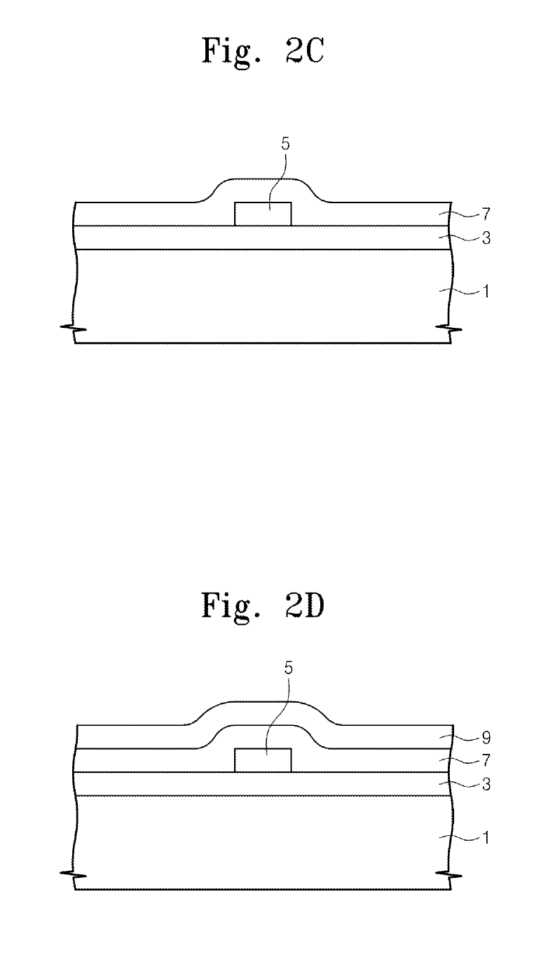

FIGS. 2A through 2D are sectional views illustrating a method of fabricating a ring waveguide of a ring resonator according to example embodiments of the inventive concept. FIGS. 2A through 2D are sectional views of a ring waveguide taken along a line I-I′ of FIG. 1A.

Referring to FIG. 2A, a lower dielectric layer 3 may be formed on a substrate 1. The substrate 1 may be a silicon substrate or a glass substrate. The lower dielectric layer 3 may be a silicon oxide layer (e.g., of SiO₂).

Although a thickness of the lower dielectric layer 3 may not be limited to a specific value, it can be modified according to required characteristics of optical devices. For example, the lower dielectric layer 3 may be formed to have a thickness of about 5 μm or less. In this case, it is possible to block an inflow of impurities and prevent the ring waveguide from being badly affected by the lower dielectric layer 3.

A core layer 5a may be formed on the lower dielectric layer 3. The core layer 5a may include a material having a refractive index greater than the lower dielectric layer 3. For example, the core layer 5a may include at least one of silicon (Si) and silicon nitride (Si₃N₄). The lower dielectric layer 3 and the core layer 5a may be formed using a deposition process. For example, the lower dielectric layer 3 and the core layer 5a may be formed using a plasma enhanced vapor deposition (PECVD) or a low pressure CVD (LPCVD). In other embodiments, the substrate 1 may be a silicon-on-insulator (SOI) substrate including the lower dielectric layer 3 and the core layer 5a. In this case, the lower dielectric layer 3 may be a silicon oxide layer, and the core layer 5a may be formed of a silicon layer.

A thermal treatment process may be further performed on the core layer 5a. The thermal treatment process may be performed at a temperature ranging from about 900° C. to 1000° C., for about 30 minutes or more. As the result of the thermal treatment process, hydrogen and/or hydroxyl radicals (OH—) may be removed from the core layer 5a. This enables to increase a density of the core layer 5a.

Referring to FIG. 2B, the core layer 5a may be patterned to form a core pattern 5. The core pattern 5 may be formed by a photolithography process. For example, the formation of the core pattern 5 may include forming a photoresist pattern (not shown), etching the core layer 5a using the photoresist pattern as an etch mask, and removing the photoresist pattern. In example embodiments, the core pattern 5 may be formed to have a width of about 0.7-1.5 μm and a height of about 150 nm-220 nm. The core pattern 5 may serve as an optical path for a light propagation.

Referring to FIG. 2C, a supplementary dielectric layer 7 may be formed on the substrate 1 provided with the core pattern 5. The supplementary dielectric layer 7 may be a silicon oxynitride layer (SiON). The supplementary dielectric layer 7 may be formed using a deposition process, for example, PECVD or LPCVD. In example embodiments, the supplementary dielectric layer 7 may be formed to have the same thickness as the lower dielectric layer 3.

The supplementary dielectric layer 7 may be formed to cover the core pattern 5, thereby protecting the core pattern 5 against external effects. The supplementary dielectric layer 7 may be used as a part of the optical waveguide in conjunction with the core pattern 5. In other embodiments, the formation of the supplementary dielectric layer 7 may be omitted.

Referring to FIG. 2D, an upper dielectric layer 9 may be formed on the supplementary dielectric layer 7. The upper dielectric layer 9 may be formed of a material, whose refractive index is uniform and is lower than that of the core pattern 5. In example embodiments, the upper dielectric layer 9 may be at least one of silicon oxide (SiO2) or a polymer (e.g., imide or acrylate).

The upper dielectric layer 9 may be formed using a deposition process, such as PECVD, LPCVD, or atmospheric pressure CVD (APCVD). In example embodiments, a thermal annealing process may be performed on the deposited upper dielectric layer 9 to improve uniformity in refractive index of the upper dielectric layer 9. The lower and upper clad layer 3 and 9 may be formed of the same material, thereby having substantially the same refractive index as each other.

Methods of forming a ring waveguide described with reference to FIGS. 2A through 2D can be applied to form the first and second waveguides 110 and 120 shown in FIGS. 1A and 1B.

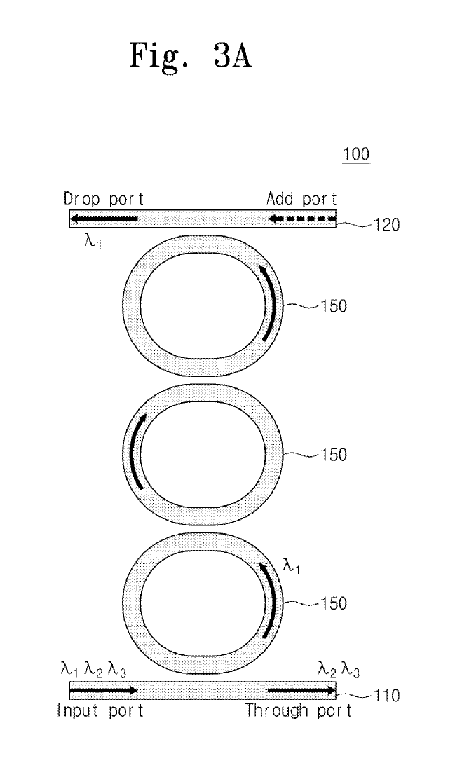

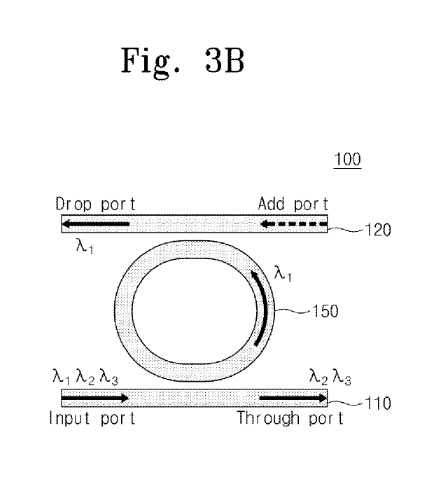

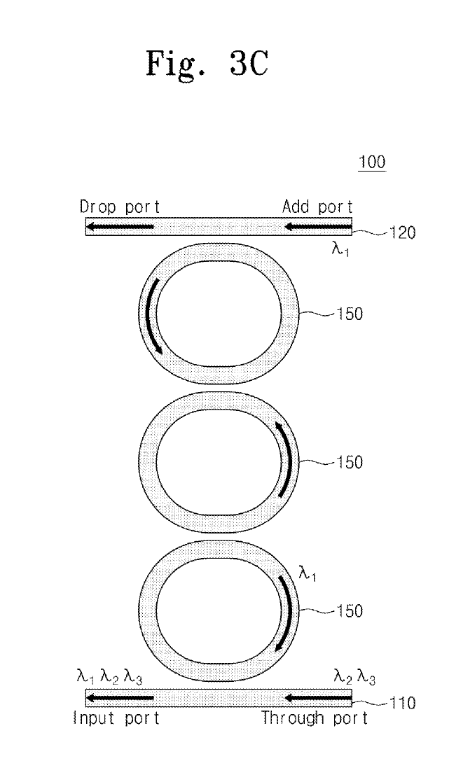

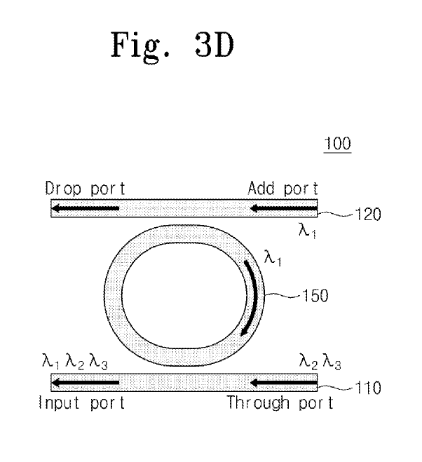

FIGS. 3A through 3D are diagrams illustrating an operation principle of a ring resonator according to example embodiments of the inventive concept. FIGS. 3A and 3C are schematic diagrams of a third-order ring resonator with 3 ring waveguides, and FIGS. 3B and 3D are schematic diagrams of a first-order ring resonator with one ring waveguide.

Referring to FIGS. 3A through 3D, a ring resonator 100 may include first and second waveguides 110 and 120. The first waveguide 110 may include an input port and a through port, and the second waveguide 120 may include a drop port and an add port. One or more ring waveguides 150 may be disposed between the first and second waveguides 110 and 120 to form a unit channel. Although FIGS. 3A through 3D show one channel, other ring waveguides 150 may be further disposed between the first and second waveguides 110 and 120 to form a plurality of channels.

Referring to FIGS. 3A and 3B, the ring resonator may serve as a demultiplexer (DEMUX) of a multi-channel filter.

For example, channel signals may be incident to the input port of the first waveguide 110. The channel signals may include first to third signals λ₁, λ₂, and λ₃, whose wavelengths are different from each other. In the case where the first signal λ₁ has the same wavelength as a resonance wavelength of the ring waveguide 150 but the second and third signals λ₂ and λ₃ have different wavelengths from the resonance wavelength of the ring waveguide 150, the first signal λ₁ may propagate to the drop port of the second waveguide 120 via the ring waveguide 150 and the second and third signals λ₂ and λ₃ may propagate to the through port, not the drop port. However, the second and third signals λ₂ and λ₃ may propagate to the drop port through other ring waveguide(s) 150 constituting other channels. Accordingly, the ring resonator 100 can be used as the demultiplexer or as an allotter selectively connecting one of several outputs to one input.

In other embodiments, the ring resonator may serve as an add-drop switch. For example, if the ring waveguide 150 is adjusted to have a resonance wavelength different from a wavelength of the first signal λ₁, the first signal λ₁ incident to the input port may propagate to the through port but not the drop port. Thereafter, if the ring waveguide 150 is adjusted to have a resonance wavelength equivalent to the wavelength of the first signal λ₁, the first signal λ₁ may propagate from the input port to the drop port.

In the case where a plurality of the ring waveguides 150 are provided as shown in FIG. 3A, the function of the add-drop switch can be realized by adjusting a resonance wavelength of at least one of the ring waveguides 150. Furthermore, if the ring waveguides 150 are configured to have temporally adjustable resonance wavelengths, the ring resonator 100 may serve as a modulator with a modulation rate of about 10 GHz or more.

Referring to FIGS. 3C and 3D, the ring resonator 100 may serve as a multiplexer (MUX) of a multi-channel filter. For example, the first signal λ₁ may be incident to the add port of the second waveguide 120 and the second and third signals λ₂ and λ₃ may be incident to the through port of the first waveguide 110. Then, the first signal λ₁ may propagate to the input port through the ring waveguide 150, and the second and third signals λ₂ and λ₃ may propagate from the through port to the input port. In other words, all the first to third signals λ₁, λ₂, and λ₃ may propagate to the input port. In this sense, the ring resonator 100 may serve as a multiplexer or a combinational circuit outputting a plurality of input signals through a single port.

The first-order ring resonator shown in FIGS. 3B and 3D may be configured to have the same function as the third-order ring resonator shown in FIGS. 3A and 3C. Due to its advantages in a cross talk with neighboring channels and in a flat-top spectral shape, the third-order ring resonator may allow to realize improved spectral characteristics, compared with the first-order ring resonator. However, resonance wavelengths of the ring waveguides 150 coupled in series should be the same as each other in order to achieve such advantages. This means that the complexity in the fabrication process increases with increasing order of ring resonators.

According to example embodiments of the inventive concept, the ring resonator 100 may be configured to have the spaces G1 and G2 of about 300 nm or more. This means that the third-order ring resonator can be fabricated using a simple and inexpensive lithography process and its fabrication process can be simplified. In addition, in the case where the ring resonator 100 is configured to include silicon waveguides, the light of TM mode can be provided for an operation of the ring resonator 100 to improve transmittance of a light having a specific wavelength.

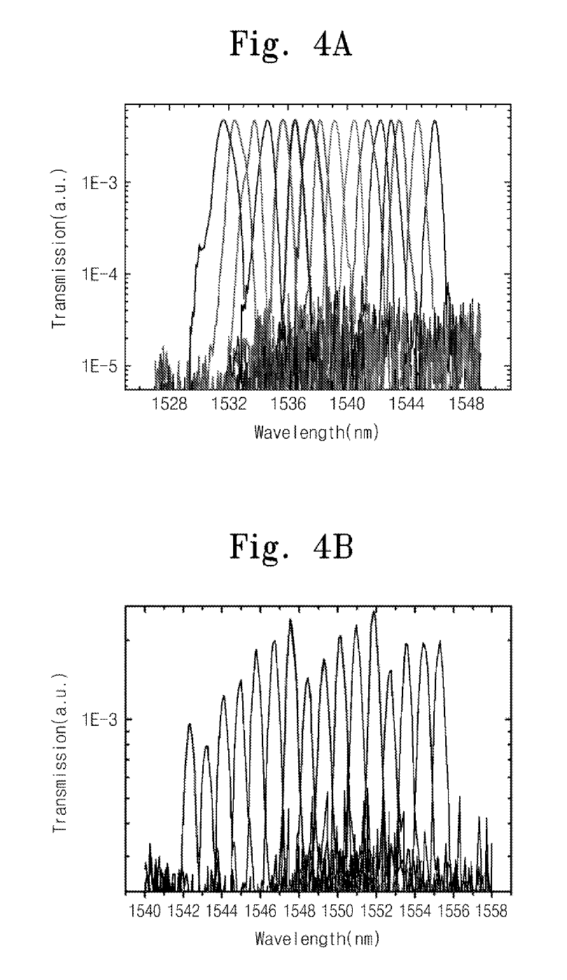

FIG. 4A is a graph showing a transmission spectrum obtained from a 16-channel third-order ring resonator, in which an optical waveguide is formed of silicon (Si), and FIG. 4B is a graph showing a transmission spectrum obtained from a 16-channel third-order ring resonator, in which an optical waveguide is formed of silicon nitride (SiN).

Referring to FIGS. 4A and 4B, transmittances of ring resonators are plotted according to a wavelength. According to example embodiments of the inventive concept, the ring resonator may be configured to include channels, each of which includes ring waveguides having transmittable wavelengths different from those of other channel and thus allows a light of specific wavelength to transmit therethrough. As a result, the ring resonator may serve as an optical switch, an optical modulator, a MUX filter, and/or a DEMUX filter, which have high reliability.

According to example embodiments of the inventive concept, the ring resonator may be configured in such a way that a space between line and ring waveguides and a space between the ring waveguides are about 300 nm or more. This enables to improve transmittance of a light having a specific wavelength and to reduce the statistical error in wavelengths of ring resonators. As a result, the ring resonator can have high reliability. Furthermore, since the spaces are 300 nm or more, the ring resonator can be fabricated using a simple and inexpensive lithography process. This enables to simplify a process of fabricating the ring resonator.

While example embodiments of the inventive concepts have been particularly shown and described, it will be understood by one of ordinary skill in the art that variations in form and detail may be made therein without departing from the spirit and scope of the attached claims.

What is claimed is:

1. A ring resonator, comprising:
first and second waveguides disposed spaced apart from each other, on a substrate; and
at least one channel including at least one ring waveguide arranged in a row between the first and second waveguides,
wherein the first and second waveguides and the ring waveguide are formed of silicon, a width of the ring waveguide ranges from 0.7 μm to 1.5 μm, a height of the ring waveguide ranges from 150 nm to 300 nm, and a space between the first and second waveguides and the ring waveguide most adjacent thereto ranges from 250 nm to 1 mm.

2. The ring resonator of claim 1, wherein each channel includes a plurality of ring waveguides provided spaced apart from each other between the first and second waveguides, and a space between the ring waveguides ranges from 250 nm to 1 mm.

3. The ring resonator of claim 1, wherein at least one channel comprises a plurality of channels provided spaced apart from each other between the first and second waveguides.

4. The ring resonator of claim 1, wherein a radius of the ring waveguide ranges from 5 μm to 15 μm.

5. The ring resonator of claim 1, wherein the first waveguide comprises an input port and a through port, and the second waveguide comprises an add port and a drop port.

6. The ring resonator of claim 1, further comprising, a dielectric layer covering the first and second waveguides and the ring waveguide,
wherein the dielectric layer is formed of oxide (SiO2) or polymer.

7. The ring resonator of claim 6, further comprising, a supplementary dielectric layer interposed between the first, second, and ring waveguides and the dielectric layer,
wherein the supplementary dielectric layer is formed of silicon oxynitride (SiON).

8. The ring resonator of claim 1, wherein the first and second waveguides and the ring waveguide are configured to allow a light of TM mode to propagate.

9. A ring resonator, comprising:
first and second waveguides disposed spaced apart from each other, on a substrate; and
at least one channel including at least one ring waveguide arranged in a row between the first and second waveguides,
wherein the first and second waveguides and the ring waveguide are formed of silicon nitride, a width of the ring waveguide ranges from 0.7 μm to 1.8 μm, a height of the ring waveguide ranges from 300 nm to 500 nm, and a space between the first and second waveguides and the ring waveguide most adjacent thereto ranges from 200 nm to 1 mm.

10. The ring resonator of claim 9, wherein each channel includes a plurality of ring waveguides provided spaced apart from each other between the first and second waveguides, and a space between the ring waveguides ranges from 200 nm to 1 mm.

11. The ring resonator of claim 9, wherein at least one channel comprises a plurality of channels provided spaced apart from each other between the first and second waveguides.

12. The ring resonator of claim 9, wherein a radius of the ring waveguide ranges from 8 μm to 50 μm.

13. The ring resonator of claim 9, wherein the first waveguide comprises an input port and a through port, and the second waveguide comprises an add port and a drop port.

14. The ring resonator of claim 9, further comprising, a dielectric layer covering the first and second waveguides and the ring waveguide,
wherein the dielectric layer is formed of oxide (SiO2) or polymer.

15. The ring resonator of claim 14, further comprising, a supplementary dielectric layer interposed between the first, second, and ring waveguides and the dielectric layer,
wherein the supplementary dielectric layer is formed of silicon oxynitride (SiON).

16. The ring resonator of claim 9, wherein the first and second waveguides and the ring waveguide are configured to allow a light of TE mode to propagate.
